(19) United States
(12) Patent Application Publication
(10) Pub. No.: US 2006/0041674 A1
(43) Pub. Date: Feb. 23, 2006

(54) Communication system and method of managing a streaming session

(75) Inventor: Jean-Marc Reme, Montigny Le Bretonneux (FR)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS N.V., Eindhoven (NL)

(21) Appl. No.: 10/528,628

(22) PCT Filed: Sep. 15, 2003
(86) PCT No.: PCT/IB03/04020

§ 371 Date: Mar. 22, 2005

(30) Foreign Application Priority Data
Sep. 25, 2002 (EP) 02292349.4

(51) Int. Cl. G06F 15/16

(52) U.S. Cl. 709/231

(57) ABSTRACT

The invention proposes a content streaming service with the options of, a) streaming a content from a server to a terminal of a user, b) interrupting the streaming session, c) resuming an interrupted streaming session from the same terminal or from another terminal belonging to that user. According to the invention, users are registered in a database. The last Random Access Point (RAP) of the interrupted streaming content is stored in the database together with the user identification data.

### FIELD OF THE INVENTION

The present invention relates to a communication system comprising a network and a server for streaming a content toward a user terminal. The invention also relates to a device hosting a user count manager to be used in such a communication system.

The invention also relates to a streaming method. The invention also relates to a program comprising instructions for implementing such a streaming method when said program is executed by a processor.

The invention also relates to a content streaming service offered to registered users.

### BACKGROUND OF THE INVENTION

U.S. patent application Ser. No. 2001/0048685A1 describes multimedia services (movie service, traffic information service, Internet search service) that are supported either by home or in-house computers or televisions with set-top box, or by mobile terminals. In the described movie service, a server downloads selected video data to a user terminal.

### OBJECT AND SUMMARY OF THE INVENTION

It is an object of the invention to propose a communication system for offering a new type of multimedia service, more specifically a new type of content streaming service.

A communication system according to the invention comprises at least a network, a server for streaming a content comprising several random access points, and a user count manager, said user count manager comprising a database of registered users, each registered user having one or more terminals with one or more connections to said network for carrying out a streaming session with said server, said database storing user identification data, said user count manager being designed so that, when a streaming session is interrupted, an indication of the streamed content and of the last random access point in the streamed content is stored in said database with said user identification data, so as to allow the resumption of the interrupted streaming session from said last random access point with any connection available to said user.

With the invention, a user having several terminals can start a streaming session with a first terminal, interrupt said streaming session, and resume the interrupted streaming session with a second terminal. For instance, a user having a wireless mobile terminal and an in-house wired terminal can start a streaming session with his mobile terminal when he is on the move, interrupt said streaming session, and resume the interrupted streaming session with his in-house wired terminal when he arrives home.

In a preferred embodiment of the invention, said database further stores user connection data comprising an identification of each connection available to said user, and for each available connection, an indication of an initial sending rate to be used for streaming a content toward said user via said connection. Furthermore, said server has access to several encoded versions of said content, each version having a specific encoding rate, and the version initially used when resuming a streaming session toward a user via a certain connection is the version whose encoding rate best matches the initial sending rate to be used for said connection.

### BRIEF DESCRIPTION OF THE DRAWINGS

These and other aspects of the invention will be further described with reference to the following drawings:

FIG. 1 is a schematic representation of an example of a communication system according to the invention,

FIG. 2 is a block diagram of a method of managing a content streaming session according to the invention.

### DESCRIPTION OF A PREFERRED EMBODIMENT

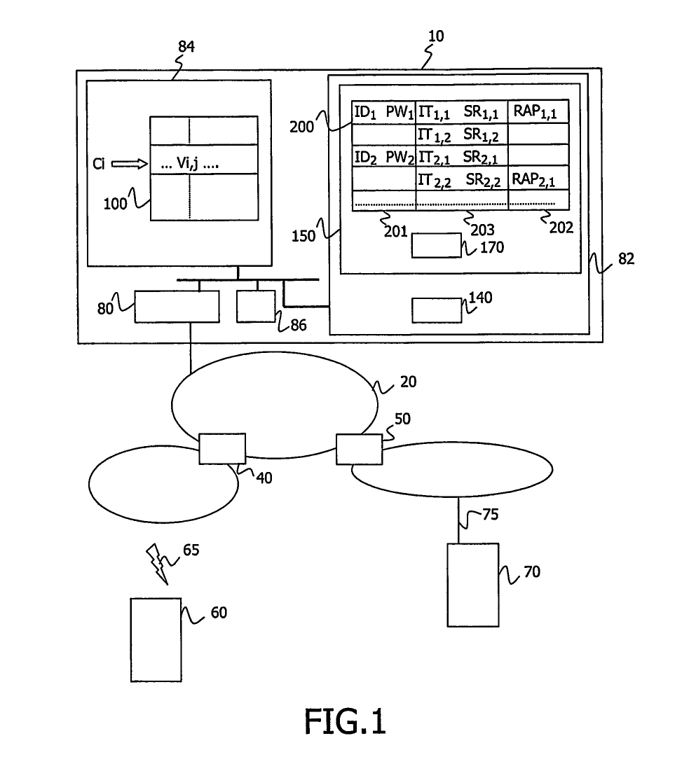

The communication system of the invention is designed to offer a content streaming service to registered users. An example of such a communication system is represented in FIG. 1. It comprises a streaming server 10 and a transmission network 20. In this preferred embodiment, the transmission network 20 is a network of the packet type, like the Internet network. It comprises an interface 40 to a radio communication network (for instance, a cellular network), and an interface 50 to a television network (for instance, a cable network). A mobile user terminal 60 can access the transmission network 20 via a radio connection 65. An in-house television terminal 70 can access the transmission network 20 via a cable connection 75.

The streaming server 10 comprises a classical transmission/reception unit 80 using the protocols RTP over UDP over IP with, in addition, known error protection and retransmission mechanisms. The streaming server 10 also comprises an application memory 82, a data memory 84, and a processing unit 86.

Internet streaming applications have to satisfy two requirements. On the one hand, the transmission network 20 is a shared environment where end systems are expected to react to congestion properly and promptly. To achieve this, the bandwidth available for the streaming application is determined on the basis of the state of the network. Thus, it could vary in an unpredictable and potentially wide fashion. On the other hand, video streaming applications require a relatively constant bandwidth to deliver a stream with a certain quality.

To satisfy these two requirements simultaneously, Internet streaming applications should be quality adaptive. That is, streaming applications should adjust the quality of the delivered stream such that the bandwidth required for transmitting the stream matches the available bandwidth.

One solution to achieve this is to switch among a plurality of pre-encoded versions of the content, each version corresponding to a different encoding rate (and hence to a different quality).

Therefore, the streaming server 10 has access to a plurality of contents and, for each content, to several pre-encoded versions of that content. In FIG. 1, the several pre-encoded versions Vᵢⱼ of several available contents Cᵢ are stored in a content database 100 in the data memory 84 of the server 10 (the suffix i refers to the content, and the suffix j refers to the version of the content). This is not restrictive. The contents to be streamed can also be stored in databases that are stored remotely from the server 10 and are accessible through the transmission network 20.

The contents stored in the content database 100 comprise random access points. For instance, the contents are compliant with the MPEG standard. In that case, the random access points are the I-frames of the MPEG file.

The streaming service offered to the registered users comprises:
carrying out a streaming session from the server 10 toward the user terminal via any connection available to the user,
interrupting the streaming session,
resuming an interrupted streaming session by using any connection available to the user.

To achieve this, a streaming module 140 and a user count manager 150 are provided. Both the streaming module 140 and the user count manager 150 are implemented in the form of software stored in the application memory 82 of the server 10. The user count manager 150 comprises a set 170 of one or more programs and a user database 200.

The user database 200 comprises at least first and second locations for each registered user. The first locations 201 are intended for storing user identification data, for instance, a user identifier IDᵤ and a user password PWᵤ defined by the user when he registers to the service (the suffix u refers to the user).

The second locations 202 are intended to contain an indication of the streamed content and of the last random access point in the streamed content when the streaming session is interrupted, so as to allow the resumption of the interrupted streaming session from said last random access point with any connection available to the user. This indication is referred to as RAP_{u,i} in the following description.

By way of example, when a file switching technology is used, the indications RAP_{u,i} can be obtained in the following manner.
All files in the content database 100 that contain a version of the same content are named after a common prefix. This common prefix is used as an indication of a streamed content in the user database 200.
For each content, the content database 100 stores a list referencing the random access points that are common to all versions of that content and associating the referenced random access points with their location in each file of the content database 100. The reference of the random access point in that list is used as an indication of the last random access point in the user database 200.

An example of such a list is given below. In this example, three versions V_{i,1}, V_{i,2} and V_{i,3} of a content Cᵢ are available in the content database 100. The version V_{i,1} corresponds to an encoding rate of 30 kbps. The version V_{i,2} corresponds to an encoding rate of 300 kbps. The version V_{i,3} corresponds to an encoding rate of 5 Mbps. Rⱼ (j=1, . . . , X) is the reference of the X random access points that are common to all versions V_{i,1} to V_{i,3}. Aₖ(Rⱼ) is the address of the random access point carrying the reference Rⱼ in the file containing the version V_{i,k}.

| | Version V_{i,1} | Version V_{i,2} | Version V_{i,3} |
|---|---|---|---|
| | (encoding rate | (encoding rate | (encoding rate |
| | 30 kbps) | 300 kbps) | 5 Mbps) |
| R₁ | A₁(R₁) | A₂(R₁) | A₃(R₁) |
| R₂ | A₁(R₂) | A₂(R₂) | A₃(R₂) |
| . . . | . . . | . . . | . . . |
| Rₓ | A₁(Rₓ) | A₂(Rₓ) | A₃(Rₓ) |

In the communication system of FIG. 1, a streaming session can be carried out between the server 10 and a user using the mobile terminal 60 or the in-house television terminal 70. Typically, the radio connection 65 offers a transmission rate of some tens of kbps (kilobits per second) while the cable connection 75 offers a transmission rate of some Mbps (megabits per second). The streaming module 140 needs to have the knowledge of the transmission rate offered by the connection for selecting the version of the content which encoding rate best matches this transmission rate before starting the streaming session. During the streaming session, the streaming module 140 may switch from one version to another in order to take into account the modifications of the state of the transmission network 20.

One solution to achieve this is that the database 200 comprises third locations 203 for storing user connection data. These user connection data are defined by the user when he registers to the service and comprise, for each connection available to the user, a connection identifiers IT_{u,v} and an initial sending rate SR_{u,v} to be used when starting or resuming a streaming session with said connection (the suffix v refers to the connection).

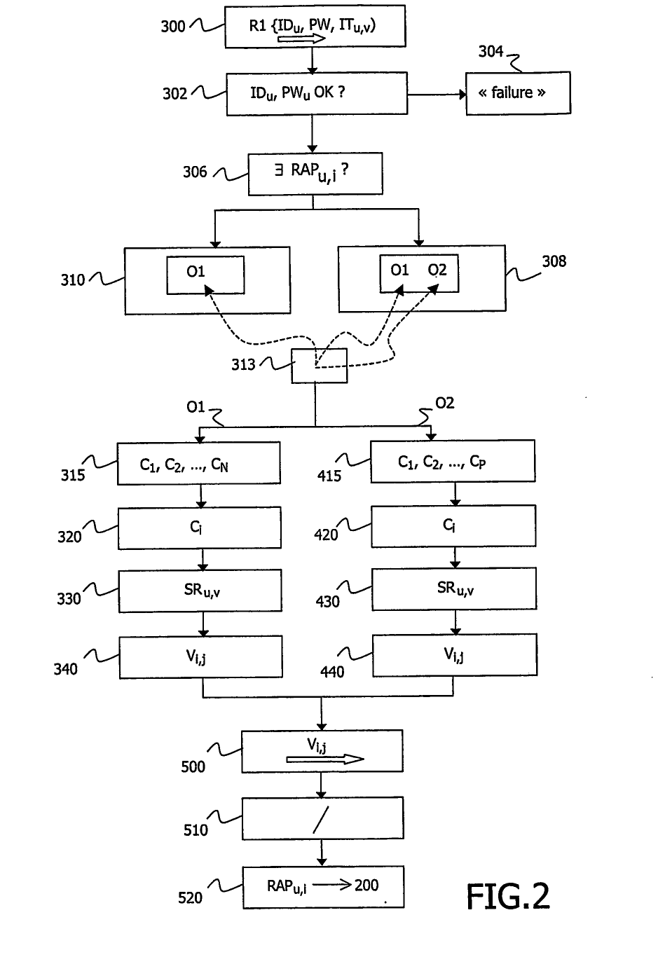

FIG. 2 is a block diagram showing the steps of a streaming method according to the invention. In this example, the proposed service is a video on demand service. This is not restrictive.

In step 300, the user sends to the server 10 via a certain connection (for instance, via the mobile terminal 60) a request RQ for access to the video on demand streaming service. This request RQ contains the user identifier IDᵤ, the user password PWᵤ and the connection identifier IT_{u,v}. In step 302, the user count manager 150 checks the user identification data IDᵤ and PWᵤ. If the user identification data are not successfully checked, the streaming module 140 sends a “failure” message to the user terminal in step 304 If the user identification data are successfully checked, the user count manager 150 checks in step 306 if one or more streaming sessions are pending for the identified user. If one or more streaming sessions are pending, in step 308 the streaming module 140 sends to the user terminal a home page of the streaming service proposing at least two options, notably an option of starting a new streaming session (option O1) and an option of resuming an interrupted streaming session (option O2). If no streaming session is pending, in step 310 the streaming module 140 sends to the user terminal a home page of the streaming service proposing the option O1, but not the option O2.

In step 313, the user makes a selection from the proposed options.

If the user selects the option O1, the streaming module 140 replies in step 315 by proposing a choice of contents C₁, C₂, . . . , C_{N}. In step 320, the user indicates the content Cᵢ that he wants to receive. In step 330, the user count manager 150 recovers in the user database 200, the initial sending rate SR_{u,v} to be used with the current terminal connection IT_{u,v}. Then, in step 340, the streaming module 140 selects in the content database 100 the version Vᵢⱼ of the content Cᵢ which encoding rate best matches the recovered initial sending rate SR_{u,v}. The next step is step 500.

If the user selects the options O2, in step 415 the user count manager 150 recovers in the database 200 the contents which streaming was previously interrupted by the user, and the streaming module 140 replies to the terminal by proposing a list of said contents C₁, C₂, . . . , Cₚ (the interrupted contents C₁, C₂, . . . , Cₚ are identified from the indication RAP_{u,k}(k=1, . . . ,P) stored in the database 200). In step 420, the user chooses a content Cᵢ in that list. In step 430, the user count manager 150 recovers in the user database 200 the initial sending rate SR_{u,v} to be used with the current terminal connection IT_{u,v}. Then, in step 440, the streaming module 140 selects the version Vᵢⱼ of the content Cᵢ which encoding rate best matches the recovered initial sending rate SR_{u,v}. The next step is step 500.

In step 500, the streaming session is started or resumed. In step 510, the user interrupts the current streaming session. In step 520, upon interruption of the streaming session by the user, the user count manager 150 stores in the user database 200 the last random access point RAP_{u,i} in the streamed content Cᵢ in association with the user identification data IDᵤ.

In the embodiment described in FIG. 1, the user count manager 150 is hosted on the server 10. This is not restrictive. The user count manager can also be hosted on any other device with an access to the transmission network 20.

In the above-described embodiment, user connection data are stored in the database 200 when the user registers to the service. This is not restrictive either. Alternative solutions may be used. For instance, the initial sending rate to be used with the current connection could be indicated in the request sent by the user for starting a streaming session or for resuming an interrupted streaming session.

The described embodiment is directed to pre-encoded contents. However, it is also applicable to contents encoded in real time with an adaptive encoder. In that case, the encoding is adapted to the state of the network in real time.

For pre-encoded contents, file switching has been proposed as a solution for adapting to the varying state of the transmission network. Here, also alternative solutions may be used. For instance, the server could send at a constant rate packets that include an indication of their importance. In such a case, the routing equipment of the transmission network would be responsible for adapting the quantity of transmitted packets to the state of the transmission network by skipping certain packets depending on their importance.

In the above-described embodiment the connection 75 to the television network is a wired connection. It may also be a high rate wireless connection, for instance, a radio link television connection or a satellite television connection.

In the above-described embodiment, each terminal offers one single connection to the transmission network 20. It is also possible for a terminal to offer several connections of different types to the transmission network 20, for instance, a wired connection to be used by a person at home and a wireless connection to be used by a person on the move.

1. A communication system comprising at least:
a network,
a server for streaming a content comprising several random access points, and
a user count manager, said user count manager comprising a database of registered users, each registered user having one or more terminals with one or more connections to said network for carrying out a streaming session with said server, said database storing user identification data, said user count manager being designed so that, when a streaming session is interrupted, an indication of the streamed content and of the last random access point in the streamed content is stored in said database together with the user identification data, so as to allow the resumption of the interrupted streaming session from said last random access point with any type of connection available to said user.

2. A communication system as claimed in claim 1, wherein said database further stores user connection data comprising an identification of each connection available to said user, and for each available connection, an indication of an initial sending rate to be used for streaming a content toward said user via said connection.

3. A communication system as claimed in claim 2, wherein said server has access to several encoded versions of said content, each version having a specific encoding rate, and the version initially used when resuming a streaming session toward a user via a certain connection is the version whose encoding rate best matches the initial sending rate to be used for said connection.

4. A device hosting a user count manager comprising a database of registered users, said registered users having one or more terminals with one or more connections to a network for carrying out a streaming session with a server, said database being intended for storing user identification data, and said user count manager being designed so that, when a streaming session is interrupted, an indication of the streamed content and of the last random access point in the streamed content is stored in said database together with said user identification data, so as to allow the resumption of the interrupted streaming session from said last random access point with any connection available to said user.

5. A method of streaming a content comprising several random access points via a network to registered users for which user identification data are stored in a database, said registered users having one or more terminals with one or more connections to said network, said streaming method comprising the step of storing in said database, with said user identification data, when a content streaming session is interrupted, an indication of the streamed content and of the last random access point in the streamed content, so as to allow the resumption of the interrupted streaming session from said last random access point with any connection available to said user.

6. A streaming method as claimed in claim 5, wherein said database further stores user connection data comprising an identification of each connection available to said user, and for each available connection, an indication of an initial sending rate to be used for streaming a content toward said user via said connection.

7. A streaming method as claimed in claim 6, wherein several encoded versions of said content are available, each version having a specific encoding rate, and the version initially used when resuming a streaming session toward a user via a certain connection is the version whose encoding rate best matches the initial sending rate to be used for said connection.

8. A program comprising instructions for implementing a method of managing a content streaming session as claimed in claim 5 or 7.

9. A content streaming service for streaming a content comprising several random access points via a network, said service being offered to registered users having one or more terminals with one or more connections to said network, and for which user identification data are stored in a database, said content streaming service comprising an option of interrupting a streaming session and resuming an interrupted streaming session with any connection available to the user, said service being based on the storage in said database, together with said user identification data, of an indication of the streamed content and of the last random access point in the streamed content when the streaming session was interrupted, so as to allow the resumption of the interrupted streaming session from said last random access point with any connection available to said user.
